(19) United States
(12) Patent Application Publication
(10) Pub. No.: US 2021/0245718 A1
(43) Pub. Date: Aug. 12, 2021

(54) ELECTRONICALLY CONTROLLED HYDRAULIC CLEANING SYSTEM

(71) Applicant: Continental Automotive GmbH, Hannover (DE)

(72) Inventor: Torsten Hahn, Frankfurt am Main (DE)

(21) Appl. No.: 17/251,022

(22) PCT Filed: Jun. 12, 2019
(86) PCT No.: PCT/EP2019/065335

§ 371 Date: Dec. 10, 2020

(30) Foreign Application Priority Data
Jun. 22, 2018 (DE) 10 2018 210 254.6

(51) Int. Cl. B60S 1/56; B60S 1/48

(52) U.S. Cl. CPC B60S 1/56; B60S 1/481

(57) ABSTRACT

An improved low-loss cleaning system for installation in a vehicle for cleaning a transparent element of an optical or optoelectronic apparatus. In order to optimize the cleaning with minimal use of liquid with different cleaning fluids at different viscosities in a wide temperature range, it is proposed that the cleaning system has a feed pump, which conveys a cleaning fluid from a storage container with a feed pressure Pv into a hydraulic line in the direction of a cleaning unit with a spray nozzle for applying cleaning fluid to the transparent element, wherein a device is interposed in the hydraulic line and shuts off the hydraulic line in a return direction and, when activated, supplies the cleaning unit connected downstream with a working pressure that is higher than the feed pressure.

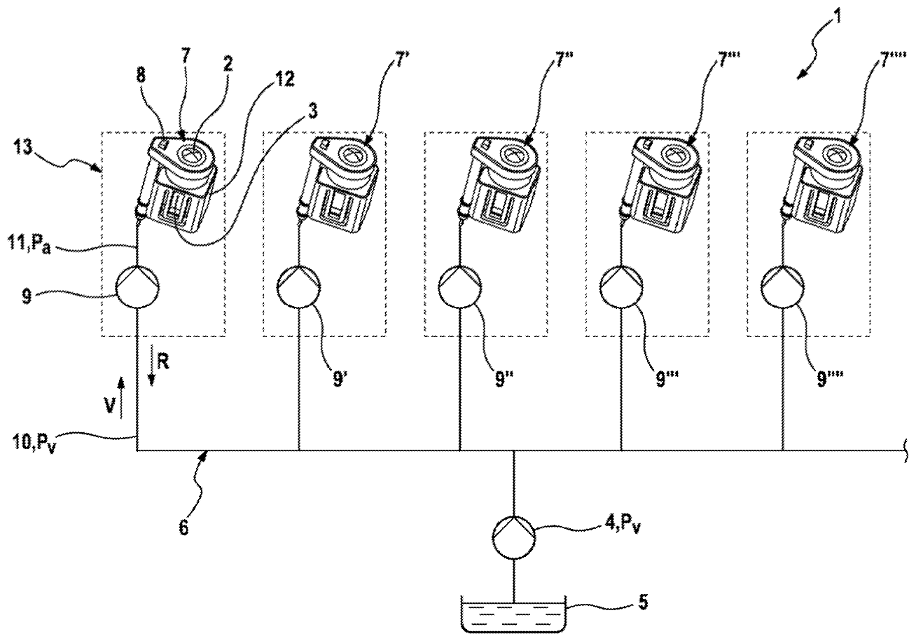

### CROSS REFERENCE TO RELATED APPLICATIONS

This application is the U.S. National Phase Application of PCT International Application No. PCT/EP2019/065335, filed Jun. 12, 2019, which claims priority to German Patent Application No. 10 2018 210 254.6, filed Jun. 22, 2018, the contents of such applications being incorporated by reference herein.

### FIELD OF THE INVENTION

The invention relates to a hydraulic cleaning system for cleaning transparent elements of optical or optoelectronic apparatuses, in particular digital cameras in a vehicle.

### BACKGROUND OF THE INVENTION

Cameras, LiDARs and comparable apparatuses for recording the vehicle environment for automated assistance and control systems of motor vehicles are attached to the outside of the vehicle and are therefore greatly exposed to environmental influences. In order to ensure their functionality, frequent cleaning cycles are required for optics to be clean at all times. Cleaning is usually carried out by a cleaning unit adjacent to the respective apparatus using an aqueous cleaning fluid which is applied to the lens, to the cover thereof or the like via a spray nozzle.

It is known to supply the cleaning units with cleaning fluid from a single central pump via hydraulic lines.

With the increasing degree of automation in vehicles, such apparatuses are used in increasing number; for example up to 20 and more objects to be cleaned may be arranged at different locations on a vehicle. This leads to a particularly high consumption of cleaning fluid and to undesirably large and heavy storage containers.

For this purpose, it is known to provide individual line sections with electromagnetic shut-off valves, with which the delivery rate for individual cleaning units can be deliberately limited and controlled.

The different viscosities of the cleaning fluid depending on the respective mixing ratio or ambient temperature are a further problem. This can lead to greatly varying sprayed delivery rates and thus to an unnecessarily high or an insufficiently low consumption of cleaning fluid per cleaning operation.

In order to avoid this and to limit consumption, it is known to use passive volume-controlled metering devices which, driven by the pressure in the hydraulic line, sequentially dispense design-defined volumes to the cleaning units connected downstream.

For an optimum cleaning result, a high pressure pulse is ideally required, which leads to an intensive burst of spray and thus removes even strongly adhering dirt. Depending on the pressure, the respective line losses also increase, these also rising proportionally to the line lengths. In the case of a central pressure supply, this requires a correspondingly large and powerful supply pump with high-pressure-resistant hose lines to compensate for the line losses, or hose lines that can be difficult to lay and have a particularly large cross section to reduce the losses.

### SUMMARY OF THE INVENTION

Against this background, an aspect of the invention is based proposing a low-loss cleaning system with which optimal cleaning to ensure the function of optical or optoelectronic apparatuses is possible with minimal use of liquids with different cleaning fluids at different viscosities in a wide temperature range.

### BRIEF DESCRIPTION OF THE DRAWINGS

An aspect of the present invention and the advantages thereof will be explained in more detail below with reference to the illustration in the FIGURE.

The FIGURE illustrates an exemplary embodiment of the cleaning system 1 according to an aspect of the invention in highly simplified form.

### DETAILED DESCRIPTION OF THE PREFERRED EMBODIMENTS

A hydraulic cleaning system (1) for installation is fed with cleaning fluid from a storage container (5) by a feed pump (4). Said cleaning fluid is pumped at a feed pressure Pv in the feed direction V into a hydraulic line (6) which can have a plurality of branches. Each branch ends with a cleaning unit 7, 7′, 7″ . . . which has one or more spray nozzles 8 from which the cleaning fluid is applied to the transparent element (2) of an associated apparatus 3; in the example shown to the lens of a camera. In the embodiment shown, the cleaning unit 7 is accommodated in a common housing combined with the apparatus 3 to form a common structural or assembly unit 12.

In the direct vicinity of each cleaning unit 7, a positive displacement pump 9 is in each case used in the hydraulic line 6.

Positive displacement pumps have a design-related property of conveying the fluid sequentially as defined limited volumes, and therefore precise metering can be achieved through targeted control of the displaced volume. Normally, the backflow of the fluid in the case of a positive displacement pump is basically prevented structurally by suitable measures, for example internal check valves or direction-dependent sealing elements.

As a result, the hydraulic line (6) always remains shut off in the return direction (R) even when the positive displacement pump 9 is at a standstill, and the cleaning system 1 can always be kept filled and ready for use without additional check valves.

When the positive displacement pump 9 is activated, the cleaning fluid provided by the feed pump 4 at the feed pressure Pv is passed on to the cleaning unit (7) connected downstream with a significantly increased working pressure (Pa), preferably in the form of a high-pressure pulse.

The individually adaptable controllability of the positive displacement pump 7 makes it possible for the respectively required amount of cleaning fluid to be always precisely provided for the consumer connected downstream under all operating conditions irrespective of viscosity and temperature.

In this way, for example, electromagnetic shut-off valves and other known means for metering the delivery rate of cleaning fluid can be substituted.

The positive displacement pump 9 can be controlled flexibly depending on the type of pump used, for example over the duration of the running time or in a pulse-like manner, for example for individual piston strokes.

A piston-type positive displacement pump can preferably be used within an aspect of the invention. This can for example be dimensioned in such a way that the amount of cleaning fluid required for a complete cleaning operation is conveyed by a single piston stroke.

As a result, the positive displacement pump 9 can be configured as what is referred to as a “slow runner”, and there is thus a noise reduction compared to what are referred to as high-speed runners. In the case of “high-speed runners”, the required cleaning volume is made available through a plurality of partial volumes that are conveyed sequentially within a very short time. These can be, for example, diaphragm pumps or piston pumps with low displacement volumes.

Should, however, a single piston stroke be insufficient, a plurality of piston strokes can be carried out for larger required cleaning volumes.

Since the working pressure Pa is generated by the positive displacement pump 9 only immediately upstream of the cleaning unit 7, the feed pressure Pv can be relatively low. The hydraulic line 6 is thereby divided into a low-pressure portion 10 and a high-pressure portion 11.

The lower feed pressure Pv means that neither large pressure losses nor large pressure forces arise in the low-pressure portion 10, and therefore particularly simple, cost-effective hose lines having small cross sections and very long line lengths become possible. The feed pump 4 can likewise be configured with a comparatively low power, and so as to be cost-effective and quiet.

Only the substantially shorter high-pressure portion 11 has to be equipped with stiffer hose lines of higher strength.

In order to further minimize pressure losses and reduce reaction times, the positive displacement pump 9 and cleaning unit 7 and the apparatus 3 can be arranged combined as an individual structural unit 13, in particular in a common housing, provided that the available structural space permits this.

In addition, positive displacement pumps are mostly self-priming, which means that the system can be vented without additives.

In the embodiment shown, five individual positive displacement pumps 9 to 9″″, each with a cleaning unit 7-7″″ connected downstream, are provided in the cleaning system 1.

Within an aspect of the invention, however, the number can be varied as desired to meet requirements.

### LIST OF REFERENCE SIGNS

1 Cleaning system
2 Transparent element
3 Optical or optoelectronic apparatus
4 Feed pump
5 Storage container
6 Hydraulic line
7 Cleaning unit
8 Spray nozzle
9 Device
10 Low-pressure portion
11 High-pressure portion
12 Structural unit
13 Structural unit
Pv Feed pressure
Pr Cleaning pressure
R Return direction
V Feed direction

1. A hydraulic cleaning system for installation in a vehicle for cleaning at least one transparent element of at least one optical or optoelectronic apparatus for recording the vehicle environment, comprising:
a feed pump, which conveys a cleaning fluid from a storage container with a feed pressure into a hydraulic line in a feed direction,
at least one cleaning unit, which is connected to the line and has at least one spray nozzle for applying the cleaning fluid to the transparent element,
at least one electronically controllable device, which is interposed in the hydraulic line between the feed pump and the cleaning unit,
wherein the device shuts off the hydraulic line in a return direction opposite to the feed direction and, when activated, supplies at least one cleaning unit connected downstream with a working pressure that is higher than the feed pressure.

2. The cleaning system as claimed in claim 1, wherein the device is configured as a positive displacement pump.

3. The cleaning system as claimed in claim 2, wherein the cleaning system has a plurality of positive displacement pumps which are supplied by a common feed pump, wherein each positive displacement pump is assigned at least one cleaning unit.

4. The cleaning system as claimed in claim 3, wherein in each case a single cleaning unit for individual supply is connected downstream of each positive displacement pump.

5. The cleaning system as claimed in claim 2, wherein an amount of cleaning fluid dispensed by the cleaning unit in an individual cleaning operation is controlled by a running time control of the positive displacement pump connected upstream.

6. The cleaning system as claimed in claim 2, wherein the positive displacement pump is configured as a piston pump, and an amount of cleaning fluid dispensed during an individual cleaning operation by the cleaning unit connected downstream of the positive displacement pump is controlled by the number of piston strokes of the positive displacement pump.

7. The cleaning system as claimed in claim 6, wherein the amount of cleaning fluid dispensed during an individual cleaning operation is conveyed with a single piston stroke of the positive displacement pump.

8. The cleaning system as claimed in claim 1, wherein a first portion of the hydraulic line delimited by the feed pump and the device is configured as a low-pressure portion, and a second portion of the hydraulic line delimited by the device and the cleaning unit is configured as a high-pressure portion, wherein the hydraulic line has a higher strength in the high-pressure portion than in the low-pressure portion.

9. The cleaning system as claimed in claim 1, wherein the cleaning unit is formed combined in a common housing with the associated apparatus, and the device is arranged in the direct vicinity of the associated cleaning unit.

10. The cleaning system as claimed in claim 1, wherein the device is formed combined together with the associated cleaning unit and the apparatus in a common housing.
